(19) United States
(12) Patent Application Publication
(10) Pub. No.: US 2025/0337341 A1
(43) Pub. Date: Oct. 30, 2025

(54) VOLTAGE CONVERTING DEVICE AND METHOD OF OPERATING THE SAME

(71) Applicant: Samsung Electronics Co., Ltd., Suwon-si (KR)

(72) Inventors: Keonwoo KIM, Suwon-si (KR); Moonyoung KIM, Suwon-si (KR); Jeongil KANG, Suwon-si (KR); Haedeun KIM, Suwon-si (KR)

(21) Appl. No.: 19/258,608

(22) Filed: Jul. 2, 2025

Related U.S. Application Data
(63) Continuation of application No. PCT/KR2023/020968, filed on Dec. 19, 2023.

(30) Foreign Application Priority Data
Feb. 1, 2023 (KR) 10-2023-0013657

(51) Int. Cl. H02M 7/217; H02M 1/08; H02M 1/42

(52) U.S. Cl. CPC H02M 7/217; H02M 1/08; H02M 1/4208

(57) ABSTRACT

A voltage converting device may comprise: a bridge rectifier configured to rectify an input voltage and outputs a first AC voltage; a power factor corrector comprising circuitry configured to convert the first AC voltage into a first DC voltage based on power factor correction; a DC-DC converter configured to convert the first DC voltage into a second DC voltage; and a PFC controller comprising circuitry configured to control at least one of the bridge rectifier, the power factor corrector, and the DC-DC converter. The bridge rectifier may be configured to output the first AC voltage by rectifying the input voltage using at least one operational amplifier, at least one switch, at least one diode, and at least one resistor.

### CROSS-REFERENCE TO RELATED APPLICATIONS

This application is a continuation of International Application No. PCT/KR2023/020968 designating the United States, filed on Dec. 19, 2023, in the Korean Intellectual Property Receiving Office and claiming priority to Korean Patent Application No. 10-2023-0013657, filed on Feb. 1, 2023, in the Korean Intellectual Property Office, the disclosures of each of which are incorporated by reference herein in their entireties.

### BACKGROUND

### Field

The disclosure relates to a voltage converting device and a method of operating the same, and for example, to a voltage converting device including a low-cost semi-active bridge rectifier implemented with an operational amplifier and a resistor, and a method of operating the same.

### Description of Related Art

In voltage converting devices, a bridge rectifier is a component used to change AC voltage into DC voltage. The power conversion unit of the voltage converting device includes a bridge rectifier including a bridge diode. The loss occurring in the bridge diode is determined by the product of the current I flowing through the bridge rectifier and the forward voltage drop VF of the bridge diode. Due to high voltage stress, the bridge diode has a high forward voltage drop, which is a major cause of reduced efficiency in the entire power conversion unit.

To enhance the efficiency reduction in the power conversion unit, an active bridge rectifier has been proposed, in which the bridge diode has been replaced with a switch. When the resistance component of the MOSFET of the active bridge rectifier is R_{ds,on}, a loss of I²*R_{ds,on} may occur in the active bridge rectifier. Because the loss (e.g., I²*R_{ds, on}) occurring in the active bridge rectifier is lower than the loss (e.g., I*VF) occurring in the conventional bridge rectifier, the active bridge rectifier is superior to the conventional bridge rectifier in terms of efficiency. However, in the case of a switch positioned at the top of the bridge rectifier of the active bridge rectifier, the source is not connected to the GND, and thus, a separate element (e.g., a high-side driver based on a floating gate driver) is required to drive the switch, which increases the manufacturing cost.

Therefore, a voltage converting device with a relatively lower manufacturing cost than an active bridge rectifier and an increased efficiency of the power conversion unit than a conventional bridge rectifier is required.

### SUMMARY

Embodiments of the disclosure may provide a voltage converting device including a semi-active bridge rectifier implemented using an operational amplifier, a resistor, and a switch, and a method of operating the same.

A voltage converting device according to various example embodiments of the disclosure may comprise: a bridge rectifier configured to rectify an input voltage and to output a first AC voltage, a power factor corrector comprising circuitry configured to convert the first AC voltage into a first DC voltage based on power factor correction, a DC-DC converter configured to convert the first DC voltage into a second DC voltage, and a power factor correction (PFC) controller comprising circuitry configured to control at least one of the bridge rectifier, the power factor corrector, and the DC-DC converter. The bridge rectifier may output the first AC voltage by rectifying the input voltage using at least one operational amplifier, at least one switch, at least one diode, and at least one resistor.

In an example embodiment, the bridge rectifier may include: a first resistor connected between a first end of an input terminal to which the input voltage may be applied and a first node, a second resistor connected between a second end of the input terminal and a second node, a third resistor connected between the first node and a ground end, and a fourth resistor connected between the second node and the ground end.

In an example embodiment, the bridge rectifier may be configured to extract a first half-wave voltage from the first node based on a resistance ratio between the first resistor and the third resistor. The bridge rectifier may be configured to extract a second half-wave voltage from the second node based on a resistance ratio between the second resistor and the fourth resistor.

In an example embodiment, the bridge rectifier may include: a first diode connected between the first end of the input terminal to which the input voltage may be applied and a third node, a second diode connected between the second end of the input terminal and the third node, a first switch connected between the first end of the input terminal and the ground end, and a second switch connected between the second end of the input terminal and the ground end.

In an example embodiment, the bridge rectifier may include: a first gate control unit comprising circuitry connected to a gate of the first switch, and a second gate control unit comprising circuitry connected to a gate of the second switch.

In an example embodiment, the first gate control unit may include: a first operational amplifier including a first input end, a second input end, and an output end, and a first on-off control unit comprising circuitry connected between the output end of the first operational amplifier and the gate of the first switch, wherein the first on-off control unit comprises a first turn-on resistor, a first turn-off resistor, and a first turn-off diode.

In an example embodiment, the first operational amplifier may be configured to receive the second half-wave voltage through the first input end. The first operational amplifier may be configured receive the first half-wave voltage through the second input end.

In an example embodiment, the first gate control unit may include: a first input diode connected to the first input end of the first operational amplifier, a second input diode connected to the second input end of the first operational amplifier, and an offset diode configured to input an offset voltage to the second input end, the offset voltage being divided from a power supply voltage in a specified ratio by a first voltage dividing resistor and a second voltage dividing resistor.

In an example embodiment, the first gate control unit may be configured to provide an offset voltage to the second input end of the first operational amplifier. The first operational amplifier may be configured to output an amplified voltage to the output end based on a voltage input to the first input end is greater than a voltage input to the second input end based on the offset voltage.

In an example embodiment, the second gate control unit may include: a second operational amplifier including a first input end, a second input end, and an output end, and a second on-off control unit comprising circuitry connected between the output end of the second operational amplifier and the gate of the second switch, wherein the second on-off control unit comprises a second turn-on resistor, a second turn-off resistor, and a second turn-off diode.

In an example embodiment, the second operational amplifier may be configured to receive the first half-wave voltage through the first input end. The second operational amplifier may be configured to receive the second half-wave voltage through the second input end.

In an example embodiment, the PFC controller may include: a power factor correction integrated circuit (PFC IC) including an input voltage AC (VINAC) pin, a first VINAC diode configured to input the first half-wave voltage to the VINAC pin, a second VINAC diode configured to input the second half-wave voltage to the VINAC pin, a VINAC resistor connected between the VINAC pin and the ground end, and a VINAC capacitor connected between the VINAC pin and the ground end.

In an example embodiment, the PFC IC may be configured to receive, through the VINAC pin, a VINAC voltage generated based on the first half-wave voltage and the second half-wave voltage being OR-ed.

A semi-active bridge rectification circuit according to various example embodiments of the disclosure may comprise: a first resistor connected between a first end of an input terminal to configured to have an input voltage applied thereto and a first node, a second resistor connected between a second end of the input terminal and a second node, a third resistor connected between the first node and a ground end, a fourth resistor connected between the second node and the ground end, a first diode connected between the first end of the input terminal and a third node, a second diode connected between the second end of the input terminal and the third node, a first switch connected between the first end of the input terminal and the ground end, and a second switch connected between the second end of the input terminal and the ground end.

In an example embodiment, the semi-active bridge rectification circuit may further comprise: a first gate control unit comprising circuitry connected to a gate of the first switch, and a second gate control unit comprising circuitry connected to a gate of the second switch. The first gate control unit and the second gate control unit may be configured to receive at least one of a first half-wave voltage and a second half-wave voltage extracted from the input voltage. The first gate control unit and the second gate control unit may be configured to control an operation of the first switch and the second switch based on at least one of the first half-wave voltage and the second half-wave voltage.

In an example embodiment, the first gate control unit may include: a first operational amplifier including a first input end, a second input end, and an output end, and a first on-off control unit comprising circuitry connected between the output end of the first operational amplifier and the gate of the first switch, wherein the first on-off control unit comprises a first turn-on resistor, a first turn-off resistor, and a first turn-off diode.

In an example embodiment, the first gate control unit may include: a first input diode connected to the first input end of the first operational amplifier, a second input diode connected to the second input end of the first operational amplifier, and an offset diode configured to input an offset voltage to the second input end, the offset voltage being divided from a power supply voltage in a specified ratio by a first voltage dividing resistor and a second voltage dividing resistor.

A method of operating a voltage converting device according to various example embodiments of the disclosure may comprise: rectifying an input voltage to output a first AC voltage, converting the first AC voltage into a first DC voltage based on power factor correction, and converting the first DC voltage into a second DC voltage. Wherein the rectifying the input voltage to output a first AC voltage may extract a first half-wave voltage and a second half-wave voltage from the input voltage using at least one resistor. Wherein the rectifying the input voltage to output a first AC voltage may input the first half-wave voltage and the second half-wave voltage to at least one operational amplifier. Wherein the rectifying the input voltage to output the first AC voltage may control the gate of at least one switch based on the output of the operational amplifier. Wherein the rectifying the input voltage to output a first AC voltage may output the first AC voltage based on the operation of the at least one switch.

In an example embodiment, the rectifying the input voltage to output the first AC voltage may provide an offset voltage to an input end of the at least one operational amplifier. The rectifying the input voltage to output a first AC voltage may control a turn-on time and a turn-off time of the at least one switch based on an amplification voltage output from the operational amplifier.

In an example embodiment, the method of operating the voltage converting device may further include: controlling at least one of the bridge rectifier, the power factor corrector, and the DC-DC converter. The controlling at least one of the bridge rectifier, the power factor corrector, and the DC-DC converter may apply to a VINAC pin a VINAC voltage generated based on the first half-wave voltage and the second half-wave voltage being OR-ed, and control at least one of the bridge rectifier, the power factor corrector, and the DC-DC converter, based on the VINAC voltage input through the VINAC pin.

According to various example embodiments of the disclosure, the voltage converting device of the disclosure includes a semi-active bridge rectifier implemented using an operational amplifier, a resistor, and a switch, thereby minimizing and/or reducing manufacturing costs.

The voltage converting device and its operating method of the disclosure may maximize and/or increase power efficiency by utilizing the half-wave voltage for the input voltage to minimize and/or reduce standby power.

The voltage converting device and its operating method of the disclosure may stabilize the rectification operation for the input voltage by utilizing the offset voltage to control the switch operation of the bridge rectifier.

Effects achievable by various example embodiments of the disclosure are not limited to the above-mentioned effects, but other effects not mentioned may be apparently derived and understood by one of ordinary skill in the art to which example embodiments of the disclosure pertain, from the following detailed description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a voltage converting device according to an embodiment;

FIG. 2 is a circuit diagram illustrating an example configuration of a bridge rectifier according to an embodiment;

FIG. 3 is a circuit diagram illustrating an example configuration of a PFC controller according to an embodiment;

FIGS. 4A, 4B and 4C are waveforms of a first half-wave voltage, a second half-wave voltage, and a VINAC voltage according to an embodiment;

FIG. 5 are simulation waveforms of a voltage converting device according to an embodiment;

FIG. 6 is a circuit diagram illustrating an example configuration of a bridge rectifier according to an embodiment;

FIG. 7 are simulation waveforms of a voltage converting device according to an embodiment; and

FIG. 8 is a flowchart illustrating an example method of operating a voltage converting device according to an embodiment.

### DETAILED DESCRIPTION

Hereinafter, various example embodiments of the disclosure are described in greater detail with reference to the drawings. However, the disclosure may be implemented in other various forms and is not limited to the example embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

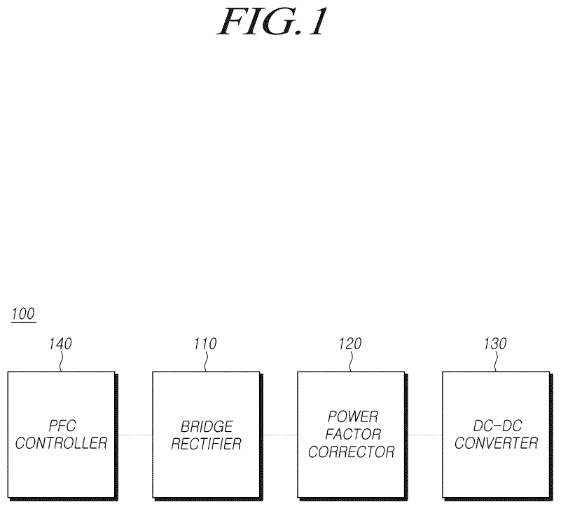

FIG. 1 is a block diagram illustrating an example configuration of a voltage converting device 100 according to an embodiment.

Referring to FIG. 1, a voltage converting device 100 according to embodiments of the disclosure may comprise a bridge rectifier 110, a power factor corrector (e.g., including circuitry) 120, a DC-DC converter 130, and a PFC controller (e.g., including circuitry) 140.

The bridge rectifier 110 may rectify an input voltage to output a first AC voltage. For example, the bridge rectifier 110 may output the first AC voltage to the power factor corrector 120 by rectifying the input voltage using at least one operational amplifier, at least one switch, at least one diode, and at least one resistor.

The power factor corrector 120 may include various circuitry and convert the first AC voltage into a first DC voltage based on power factor correction. For example, the power factor corrector 120 may convert the first AC voltage into the first DC voltage by receiving the first AC voltage and performing AC-DC conversion on the first AC voltage via power factor correction on the first AC voltage. The power factor corrector 120 may output the first DC voltage to the DC-DC converter 130.

The DC-DC converter 130 may convert the first DC voltage into a second DC voltage. For example, the DC-DC converter 130 may convert the first DC voltage into a second DC voltage having a high voltage and output the same. For example, the DC-DC converter 130 may be implemented using at least one of a boost converter, a buck converter, a half-bridge converter, a flyback converter, a full-bridge converter, a push-pull converter, and a forward converter.

The PFC controller 140 may include various circuitry and control at least one of the bridge rectifier 110, the power factor corrector 120, and the DC-DC converter 130. For example, the PFC controller 140 may include a PFC IC for controlling at least one of the bridge rectifier 110, the power factor corrector 120, and the DC-DC converter 130. The PFC IC may include a VINAC pin that senses an input voltage (e.g., an AC input voltage input to the PFC IC). For example, the PFC IC may sense the input voltage via the VINAC pin, and perform at least one of a feed-forward control operation, a brownout operation, and an input line (high line, low line) sensing operation according to the input voltage.

The voltage converting device 100 of the disclosure includes a semi-active bridge rectifier implemented using an operational amplifier, a resistor, and a switch, thereby minimizing and/or reducing manufacturing costs. Further, the voltage converting device 100 of the disclosure may maximize and/or increase power efficiency by utilizing a half-wave input voltage to minimize and/or reduce standby power consumption.

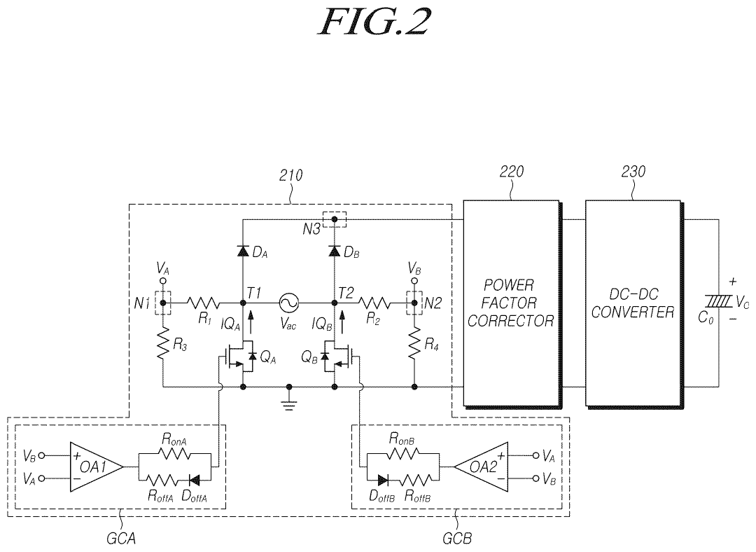

Hereinafter, an example circuit configuration of the voltage converting device of the disclosure and a rectification operation for the input voltage using a half-wave voltage are described in greater detail with reference to FIGS. 2, 3, 4A, 4B, 4C and 5 (which may be referred to as FIGS. 2 to 5).

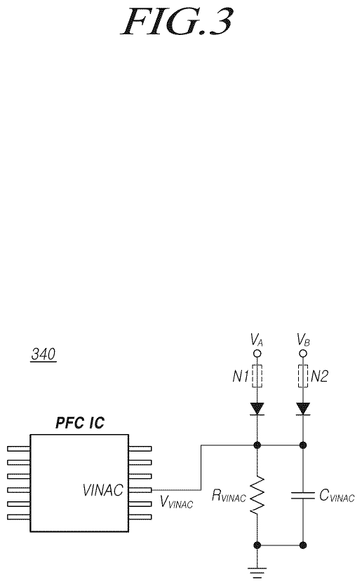

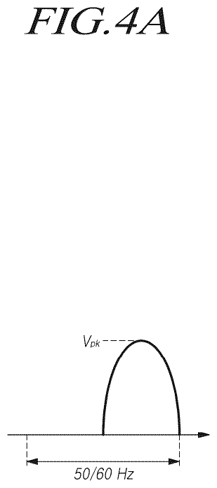

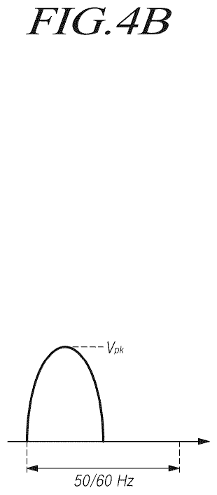

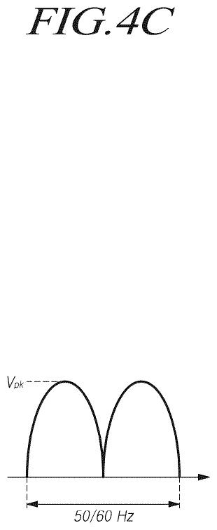

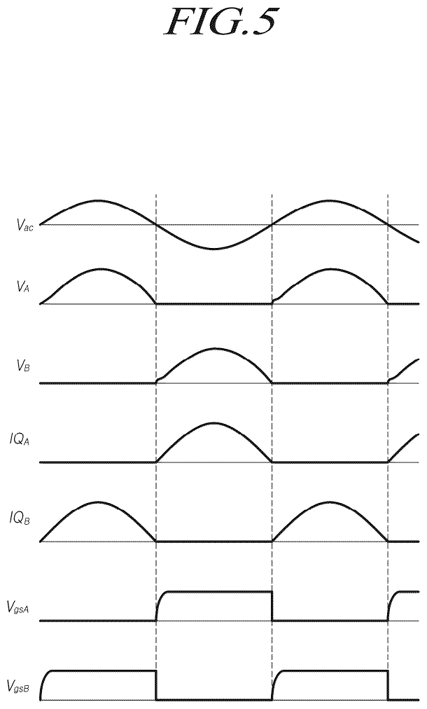

FIG. 2 is a circuit diagram illustrating an example configuration of a bridge rectifier 210 according to an embodiment, FIG. 3 is a circuit diagram illustrating an example configuration of a PFC controller 340 according to an embodiment, FIGS. 4A, 4B and 4C are waveforms of a first half-wave voltage V_{A}, a second half-wave voltage V_{B}, and a VINAC voltage V_{VINAC}, according to an embodiment, and FIG. 5 are simulation waveforms of a voltage converting device 100 according to an embodiment.

Referring to FIG. 2, the bridge rectifier 210 may include first to fourth resistors R₁ to R₄ for extracting a first half-wave voltage V_{A} and a second half-wave voltage V_{B} from an input voltage V_{ac}.

For example, the bridge rectifier 210 may include a first resistor R₁ connected between a first end T1 of an input terminal to which an input voltage V_{ac} is applied and a first node N1, a second resistor R₂ connected between a second end T2 of the input terminal and a second node N2, a third resistor R₃ connected between the first node N1 and a ground end, and a fourth resistor R₄ connected between the second node N2 and the ground end.

The bridge rectifier 210 may extract the first half-wave voltage V_{A} from the first node N1 based on a resistance ratio between the first resistor R₁ and the third resistor R₃. For example, as illustrated in FIG. 4A, the first half-wave voltage V_{A} may be a half-wave voltage corresponding to an even half-wave of the input voltage V_{ac} in a unit period (e.g., 50 Hz to 60 Hz). For example, the first half-wave voltage V_{A} may have a maximum voltage (e.g., Vₚₖ) of a predetermined magnitude.

The bridge rectifier 210 may extract the second half-wave voltage V_{B} from the second node N2 based on a resistance ratio between the second resistor R₂ and the fourth resistor R₄. For example, as illustrated in FIG. 4B, the second half-wave voltage V_{B} may be a half-wave voltage corresponding to an odd half-wave of the input voltage V_{ac} in the unit period (e.g., 50 Hz to 60 Hz). For example, the second half-wave voltage V_{B} may have a maximum voltage (e.g., Vₚₖ) of a predetermined magnitude.

The bridge rectifier 210 may include a first diode D_{A}, a second diode D_{B}, a first switch Q_{A}, and a second switch Q_{B} that rectify the input voltage V_{ac} to generate a first AC voltage.

The first diode D_{A} may be connected between the first end T1 of the input terminal to which the input voltage V_{ac} is applied and the third node N3. The second diode D_{B} may be connected between the second end T2 of the input terminal and the third node N3. For example, the first diode D_{A} and the second diode D_{B} may be power level diodes.

The first switch Q_{A} may be connected between the first end T1 of the input terminal and the ground end. The second switch Q_{B} may be connected between the second end T2 of the input terminal and the ground end. In FIG. 2, the first switch Q_{A} and the second switch Q_{B} are illustrated as having a structure in which a MOSFET and a body diode are connected in parallel, but the structure of the switch of the disclosure is not limited thereto.

The bridge rectifier 210 may include a first gate control unit GCA connected to the gate of the first switch Q_{A} and a second gate control unit GCB connected to the gate of the second switch Q_{B}.

The first gate control unit GCA may include a first operational amplifier OA1 and a first on/off control unit. For example, the first operational amplifier OA1 may include a first input end, a second input end, and an output end. For example, the first on/off control unit may include a first turn-on resistor R_{onA}, a first turn-off resistor R_{offA}, and a first turn-off diode D_{offA}. For example, the first on/off control unit may be connected between the output end of the first operational amplifier and the gate of the first switch Q_{A}.

According to an example, the first operational amplifier OA1 may receive the second half-wave voltage V_{B} through the first input end (e.g., the (+) input end). The first operational amplifier OA1 may receive the first half-wave voltage V_{A} through the second input end (e.g., the (−) input end). The output end of the first operational amplifier may output the amplified voltage to the gate of the first switch Q_{A} through the first on/off control unit.

The second gate control unit GCB may include a second operational amplifier OA2 and a second on/off control unit. For example, the second operational amplifier OA2 may include a first input end, a second input end, and an output end. For example, the second on/off control unit may include a second turn-on resistor R_{onB}, a second turn-off resistor R_{offB}, and a second turn-off diode D_{offB}. For example, the second on/off control unit may be connected between the output end of the second operational amplifier and the gate of the second switch Q_{B}.

According to an example, the second operational amplifier OA2 may receive the first half-wave voltage V_{A} through the first input end (e.g., the (+) input end). The second operational amplifier OA2 may receive the second half-wave voltage V_{B} through the second input end (e.g., the (−) input end). The output end of the second operational amplifier may output the amplified voltage to the gate of the second switch Q_{B} through the second on/off control unit.

As illustrated in the simulation waveforms of FIG. 5, the bridge rectifier 210 may perform a rectification operation on the input voltage V_{ac}, depending on the configurations of the first gate control unit GCA and the second gate control unit GCB. For example, the bridge rectifier 210 may operate as a semi-active bridge rectifier.

For example, in an interval where the second half-wave voltage V_{B} has an effective voltage (e.g., 0 to Vₚₖ) and the first half-wave voltage V_{A} does not have an effective voltage, the first gate signal V_{gsA} has a logic high level, and thus the first switch Q_{A} may be turned on. As the first switch Q_{A} is turned on, the first switch current IQ_{A} may flow through the first switch Q_{A}. Here, the first on/off control unit may control the speed at which the first gate signal V_{gsA} increases based on the first turn-on resistor R_{onA}. For example, as the first turn-on resistor R_{onA} increases, the first gate signal V_{gsA} may gradually increase. Further, the first on/off control unit may control the speed at which the first gate signal V_{gsA} decreases based on the first turn-off resistor R_{offA} and the first turn-off diode D_{offA}. For example, as the first turn-off resistor R_{offA} increases, the first gate signal V_{gsA} may slowly decrease.

For example, in an interval where the first half-wave voltage V_{A} has an effective voltage (e.g., 0 to Vₚₖ) and the second half-wave voltage V_{B} does not have an effective voltage, the second gate signal V_{gsB} has a logic high level, and thus the second switch Q_{B} may be turned on. As the second switch Q_{B} is turned on, a second switch current IQ_{B} may flow through the second switch Q_{B}. The second on/off control unit may control the speed at which the second gate signal V_{gsB} increases based on the second turn-on resistor R_{onB}. For example, as the second turn-on resistor R_{onB} increases, the second gate signal V_{gsB} may slowly increase. Further, the second on/off control unit may control the speed at which the second gate signal V_{gsB} decreases based on the second turn-off resistor R_{offB} and the second turn-off diode D_{offB}. For example, as the second turn-off resistor R_{offB} increases, the second gate signal V_{gsB} may slowly decrease.

As described above, the voltage converting device 100 of the disclosure includes a semi-active bridge rectifier implemented using an operational amplifier, a resistor, and a switch, thereby minimizing and/or reducing manufacturing costs.

According to an example, as illustrated in FIG. 3, the PFC controller 340 may include a PFC IC, a first VINAC diode, a second VINAC diode, a VINAC resistor R_{VINAC}, and a VINAC capacitor C_{VINAC}.

The PFC IC may include a VINAC pin that senses the input voltage V_{ac}. For example, the PFC IC may sense the input voltage V_{ac} via the VINAC pin, and perform at least one of a feed-forward control operation, a brownout operation, and an input line (high line, low line) sensing operation according to the input voltage V_{ac}.

The first VINAC diode may input the first half-wave voltage V_{A} to the VINAC pin. The second VINAC diode may input the second half-wave voltage V_{B} to the VINAC pin. The VINAC resistor R_{VINAC} may be connected between the VINAC pin and the ground end. The VINAC capacitor C_{VINAC} may be connected between the VINAC pin and the ground end.

The PFC IC may receive, through the VINAC pin, the VINAC voltage V_{VINAC} generated based on the first half-wave voltage V_{A} and the second half-wave voltage V_{B} being OR-ed. For example, as illustrated in FIG. 4C, when the first half-wave voltage V_{A} and the second half-wave voltage V_{B} output from the bridge rectifier 210 are OR-ed through the first node N1 and the second node N2, the VINAC voltage V_{VINAC} may have a voltage of a waveform obtained by summing the first half-wave voltage V_{A} and the second half-wave voltage V_{B}. The PFC controller 340 may control at least one of the bridge rectifier 210, the power factor corrector 220, and the DC-DC converter 230, based on the VINAC voltage V_{VINAC} input through the VINAC pin.

According to an example, when the first half-wave voltage V_{A} and the second half-wave voltage V_{B} are OR-ed, the VINAC voltage V_{VINAC} applied to the VINAC pin may be controlled based on a resistance ratio between the first to fourth resistors R₁ to R₄ of the bridge rectifier 210 and the VINAC resistor R_{VINAC} of the PFC controller 340. For example, the first resistor R₁ and the second resistor R₂ may have resistance values ranging from 5 MΩ to 10 MΩ. For example, the third resistor R₃, the fourth resistor R₄, and the VINAC resistor R_{VINAC} may have a resistance value between 10 kΩ and 100 kΩ. In other words, the main standby power consumed in the voltage converting device 100 may be changed as the magnitudes of the first and second resistors R₁ and R₂ are changed. For example, the first resistor R₁ and the second resistor R₂ may have the same resistance value. When the first resistor R₁ and the second resistor R₂ have the same resistance value, the voltage converting device 100 may control standby power by adjusting the magnitudes of the first resistor R₁, the second resistor R₂, and the VINAC resistor R_{VINAC}.

As described above, the voltage converting device 100 of the disclosure may maximize and/or increase power efficiency by utilizing the half-wave voltage for the input voltage V_{ac} to minimize and/or reduce standby power.

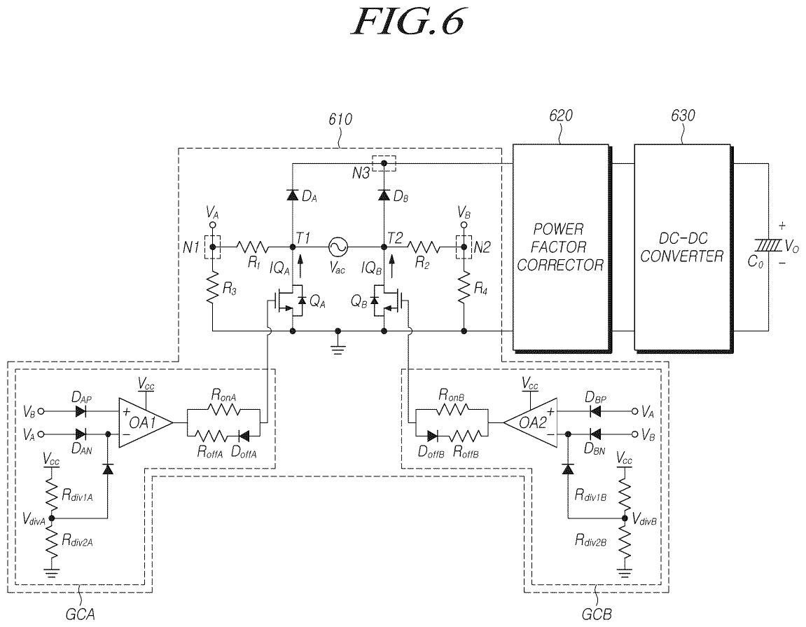

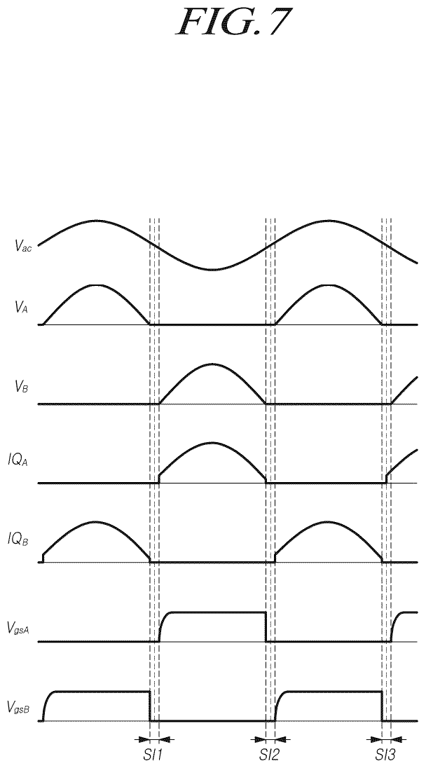

FIG. 6 is a circuit diagram illustrating an example configuration of a bridge rectifier 610 according to an embodiment, and FIG. 7 are simulation waveforms of a voltage converting device 100 according to an embodiment.

Referring to FIGS. 6 and 7, the bridge rectifier 610 may include a first resistor R₁ connected between the first end T1 of the input terminal to which the input voltage V_{ac} is applied and the first node N1, a second resistor R₂ connected between the second end T2 of the input terminal and the second node N2, a third resistor R₃ connected between the first node N1 and the ground end, and a fourth resistor R₄ connected between the second node N2 and the ground end. Further, the bridge rectifier 610 may include a first diode D_{A} connected between the first end T1 of the input terminal to which the input voltage V_{ac} is applied and the third node N3, a second diode D_{B} connected between the second end T2 of the input terminal and the third node N3, a first switch Q_{A} connected between the first end T1 of the input terminal and the ground end, and a second switch Q_{B} connected between the second end T2 of the input terminal and the ground end.

The bridge rectifier 610 may include a first gate control unit GCA connected to the gate of the first switch Q_{A} and a second gate control unit GCB connected to the gate of the second switch Q_{B}.

According to an example, the first gate control unit GCA may include a first operational amplifier OA1 including a first input end, a second input end, and an output end, and a first on/off control unit connected between the output end of the first operational amplifier and the gate of the first switch Q_{A} wherein the first on/off control unit includes a first turn-on resistor R_{onA}, a first turn-off resistor R_{offA}, and a first turn-off diode D_{offA}.

As illustrated in FIG. 6, the first gate control unit GCA may include a first input diode D_{AP} connected to the first input end of the first operational amplifier, a second input diode DAN connected to the second input end of the first operational amplifier, and an offset diode inputting an offset voltage V_{divA} to the second input end, the offset voltage being divided from a power supply voltage V_{CC} in a predetermined (e.g., specified) ratio by a first dividing resistor R_{div1A} and a second dividing resistor R_{div2A}. In this case, the first gate control unit GCA may provide an offset voltage V_{divA} to the second input end of the first operational amplifier. The first operational amplifier OA1 may output an amplified voltage to the output end when the voltage input to the first input end is higher than the voltage input to the second input end based on the offset voltage V_{divA}.

According to an embodiment, the second gate control unit GCB may include a second operational amplifier OA2 having a first input end, a second input end, and an output end, and a second on/off control unit connected between the output end of the second operational amplifier and the gate of the second switch Q_{B}, wherein the second on/off control unit includes a second turn-on resistor R_{onB}, a second turn-off resistor R_{offB}, and a second turn-off diode D_{offB}.

As illustrated in FIG. 6, the second gate control unit GCB may include a first input diode D_{BP} connected to the first input end of the second operational amplifier, a second input diode D_{BN} connected to the second input end of the second operational amplifier, and an offset diode inputting an offset voltage V_{divB} to the second input end, the offset voltage being divided from the power supply voltage in a predetermined ratio by the first dividing resistor R_{div1B} and the second dividing resistor R_{div2B}. In this case, the second gate control unit GCB may provide the offset voltage V_{divB} to the second input end of the second operational amplifier. The second operational amplifier OA2 may output an amplified voltage to the output end when the voltage input to the first input end is higher than the voltage input to the second input end based on the offset voltage V_{divB}.

As illustrated in the simulation waveform of FIG. 7, the bridge rectifier 610 may secure stabilization intervals (e.g., SI1, SI2, and SI3) in which the first gate signal V_{gsA} and the second gate signal V_{gsB} are simultaneously turned off, depending on the configurations of the first gate control unit GCA and the second gate control unit GCB.

For example, the first input diode D_{AP} connected to the first input end of the first operational amplifier, the second input diode D_{AP} connected to the second input end of the first operational amplifier, and the offset diode inputting the offset voltage to the second input end, the offset voltage being divided from the power supply voltage V_{CC} in a predetermined ratio by the first dividing resistor R_{div1A} and the second dividing resistor R_{div2A} may delay the turn-on time of the first gate signal V_{gsA} and advance the turn-off time. In other words, the first gate signal V_{gsA} may have a logic high level relatively late, and the first gate signal V_{gsA} may have a logic low level relatively quickly.

For example, the first input diode D_{AP} connected to the first input end of the second operational amplifier, the second input diode D_{AP} connected to the second input end of the second operational amplifier, and the offset diode inputting the offset voltage to the second input end, the offset voltage being divided from the power supply voltage V_{CC} in a predetermined ratio by the first dividing resistor R_{div1B} and the second dividing resistor R_{div2B} may delay the turn-on time of the second gate signal V_{gsB} and advance the turn-off time. In other words, the second gate signal V_{gsB} may have a logic high level relatively late, and the second gate signal V_{gsB} may have a logic low level relatively quickly.

According to an example, in order to equalize the delay time of the turn-on and turn-off operations of the first switch Q_{A} and the second switch Q_{B}, the first dividing resistor R_{div1A} of the first gate control unit and the first dividing resistor R_{div1B} of the second gate control unit may be configured to have the same resistance value. Likewise, the second dividing resistor R_{div2A} of the first gate control unit and the second dividing resistor R_{div2B} of the second gate control unit may be configured to have the same resistance value.

As described above, the voltage converting device 100 of the disclosure may stably perform the rectification operation on the input voltage V_{ac} by utilizing the offset voltages V_{divA} and V_{divB} to secure the stabilization intervals (e.g., SI1, SI2, and SI3) in which both the first switch Q_{A} and the second switch Q_{B} are turned off.

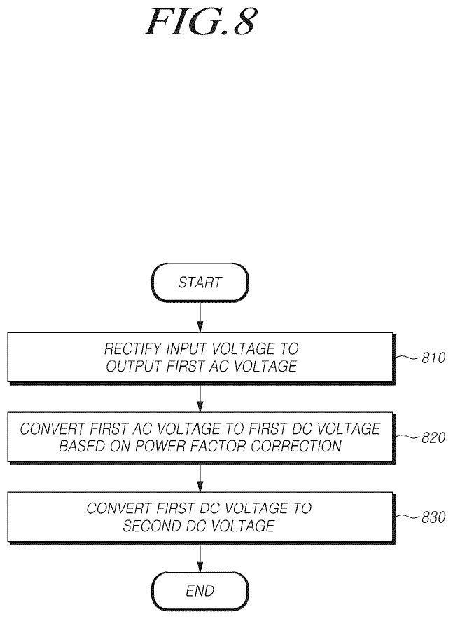

FIG. 8 is a flowchart illustrating an example method of operating a voltage converting device 100 according to an embodiment.

Referring to FIG. 8, a method of operating a voltage converting device 100 of the disclosure may comprise an operation 810 in which a bridge rectifier rectifies an input voltage V_{ac} and outputs a first AC voltage, an operation 820 in which a power factor corrector converts the first AC voltage into a first DC voltage based on power factor correction, and an operation 830 in which a DC-DC converter converts the first DC voltage into a second DC voltage.

For example, in operation 810, the bridge rectifier may rectify the input voltage V_{ac} to output a first AC voltage. For example, the bridge rectifier may output the first AC voltage to the power factor corrector by rectifying the input voltage V_{ac} using at least one operational amplifier, at least one switch, at least one diode, and at least one resistor.

For example, in operation 820, the power factor corrector may convert the first AC voltage into a first DC voltage based on the power factor correction. For example, the power factor corrector may convert the first AC voltage into the first DC voltage by receiving the first AC voltage and performing AC-DC conversion on the first AC voltage via power factor correction on the first AC voltage. The power factor corrector may output the first DC voltage to the DC-DC converter.

For example, in operation 830, the DC-DC converter may convert the first DC voltage into a second DC voltage. For example, the DC-DC converter may convert the first DC voltage into the second DC voltage having a high voltage and output the same.

According to an example, in operation 810, the voltage converting device 100 may extract the first half-wave voltage V_{A} and the second half-wave voltage V_{B} from the input voltage V_{ac} using at least one resistor. The voltage converting device 100 may input the first half-wave voltage V_{A} and the second half-wave voltage V_{B} to at least one operational amplifier. The voltage converting device 100 may control the gate of at least one switch based on the output of the operational amplifier. The voltage converting device 100 may output the first AC voltage based on the operation of the at least one switch.

In an embodiment, the method of operating the voltage converting device 100 may further include an operation of controlling at least one of the bridge rectifier, the power factor corrector, and the DC-DC converter. For example, the voltage converting device 100 may apply to the VINAC pin the VINAC voltage V_{VINAC} generated based on the first half-wave voltage V_{A} and the second half-wave voltage V_{B} being OR-ed, and control at least one of the bridge rectifier, the power factor corrector, and the DC-DC converter based on the VINAC voltage V_{VINAC} input through the VINAC pin.

As described above, the method of operating the voltage converting device 100 of the disclosure may maximize and/or increase power efficiency by utilizing the half-wave voltage for the input voltage V_{ac} to minimize and/or reduce standby power.

According to an example, in operation 810, the voltage converting device 100 may provide an offset voltage to the input end of the at least one operational amplifier. The voltage converting device 100 may control a turn-on time and a turn-off time of the at least one switch based on an amplification voltage output from the operational amplifier.

The method of operating the voltage converting device 100 of the disclosure may stabilize the rectification operation for the input voltage V_{ac} by utilizing the offset voltage to control the switch operation of the bridge rectifier.

However, since this has been described above, a duplicate description is not repeated here.

The voltage converting device according to various embodiments of the disclosure may be included in various types of electronic devices. The electronic devices may include, for example, a display device, a portable communication device (e.g., a smartphone), a computer device, a portable multimedia device, a portable medical device, a camera, a wearable device, a home appliance, or the like. The electronic device are not limited to the above-described devices.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A voltage converting device, comprising:
a bridge rectifier configured to rectify an input voltage and outputting a first AC voltage;
a power factor corrector comprising circuitry configured to convert the first AC voltage into a first DC voltage based on power factor correction;
a DC-DC converter configured to convert the first DC voltage into a second DC voltage; and
a power factor correction (PFC) controller comprising circuitry configured to control at least one of the bridge rectifier, the power factor corrector, and the DC-DC converter,
wherein the bridge rectifier is configured to output the first AC voltage by rectifying the input voltage using at least one operational amplifier, at least one switch, at least one diode, and at least one resistor.

2. The voltage converting device of claim 1, wherein the bridge rectifier includes:
a first resistor connected between a first end of an input terminal to which the input voltage is configured to be applied and a first node;
a second resistor connected between a second end of the input terminal and a second node;
a third resistor connected between the first node and a ground end; and
a fourth resistor connected between the second node and the ground end.

3. The voltage converting device of claim 2, wherein the bridge rectifier is configured to:
extract a first half-wave voltage from the first node based on a resistance ratio between the first resistor and the third resistor; and
extract a second half-wave voltage from the second node based on a resistance ratio between the second resistor and the fourth resistor.

4. The voltage converting device of claim 3, wherein the bridge rectifier includes:
a first diode connected between the first end of the input terminal to which the input voltage is configured to be applied and a third node;
a second diode connected between the second end of the input terminal and the third node;
a first switch connected between the first end of the input terminal and the ground end; and
a second switch connected between the second end of the input terminal and the ground end.

5. The voltage converting device of claim 4, wherein the bridge rectifier includes:
a first gate control unit comprising circuitry connected to a gate of the first switch; and
a second gate control unit comprising circuitry connected to a gate of the second switch.

6. The voltage converting device of claim 5, wherein the first gate control unit includes:
a first operational amplifier including a first input end, a second input end, and an output end; and
a first on-off control unit connected between the output end of the first operational amplifier and the gate of the first switch, wherein the first on-off control unit comprises a first turn-on resistor, a first turn-off resistor, and a first turn-off diode.

7. The voltage converting device of claim 6, wherein the first operational amplifier is configured to:
receive the second half-wave voltage through the first input end; and
receive the first half-wave voltage through the second input end.

8. The voltage converting device of claim 7, wherein the first gate control unit includes:
a first input diode connected to the first input end of the first operational amplifier;
a second input diode connected to the second input end of the first operational amplifier; and
an offset diode configured to input an offset voltage to the second input end, the offset voltage being divided from a power supply voltage in a specified ratio by a first voltage dividing resistor and a second voltage dividing resistor.

9. The voltage converting device of claim 7, wherein the first gate control unit is configured to provide an offset voltage to the second input end of the first operational amplifier, and
wherein the first operational amplifier is configured to output an amplified voltage to the output end based on a voltage input to the first input end being greater than a voltage input to the second input end based on the offset voltage.

10. The voltage converting device of claim 5, wherein the second gate control unit includes:
a second operational amplifier including a first input end, a second input end, and an output end; and
a second on-off control unit connected between the output end of the second operational amplifier and the gate of the second switch, wherein the second on-off control unit comprises a second turn-on resistor, a second turn-off resistor, and a second turn-off diode.

11. The voltage converting device of claim 10, wherein the second operational amplifier is configured to:
receive the first half-wave voltage through the first input end; and
receive the second half-wave voltage through the second input end.

12. The voltage converting device of claim 3, wherein the PFC controller includes:
a PFC IC including an input voltage AC (VINAC) pin;
a first VINAC diode configured to input the first half-wave voltage to the VINAC pin;
a second VINAC diode configured to input the second half-wave voltage to the VINAC pin;
a VINAC resistor connected between the VINAC pin and the ground end; and
a VINAC capacitor connected between the VINAC pin and the ground end.

13. The voltage converting device of claim 12, wherein the PFC IC is configured to receive, through the VINAC pin, a VINAC voltage generated based on the first half-wave voltage and the second half-wave voltage being OR-ed.

14. A semi-active bridge rectification circuit, comprising:
a first resistor connected between a first end of an input terminal to which an input voltage is applied and a first node;
a second resistor connected between a second end of the input terminal and a second node;
a third resistor connected between the first node and a ground end;
a fourth resistor connected between the second node and the ground end;
a first diode connected between the first end of the input terminal and a third node;
a second diode connected between the second end of the input terminal and the third node;
a first switch connected between the first end of the input terminal and the ground end; and
a second switch connected between the second end of the input terminal and the ground end.

15. The semi-active bridge rectification circuit of claim 14, further comprising:
a first gate control unit comprising circuitry connected to a gate of the first switch; and
a second gate control unit comprising circuitry connected to a gate of the second switch,
wherein the first gate control unit and the second gate control unit are configured to:
receive at least one of a first half-wave voltage and a second half-wave voltage extracted from the input voltage; and
control an operation of the first switch and the second switch based on at least one of the first half-wave voltage and the second half-wave voltage.

16. The semi-active bridge rectification circuit of claim 15, wherein the first gate control unit includes:
a first operational amplifier including a first input end, a second input end, and an output end, and
a first on-off control unit comprising circuitry connected between the output end of the first operational amplifier and the gate of the first switch, wherein the first on-off control unit comprises a first turn-on resistor, a first turn-off resistor, and a first turn-off diode.

17. The semi-active bridge rectification circuit of claim 16, wherein the first gate control unit includes:
a first input diode connected to the first input end of the first operational amplifier,
a second input diode connected to the second input end of the first operational amplifier, and
an offset diode configured to input an offset voltage to the second input end, the offset voltage being divided from a power supply voltage in a specified ratio by a first voltage dividing resistor and a second voltage dividing resistor.

18. A method of operating a voltage converting device, comprising:
rectifying an input voltage to output a first AC voltage,
converting the first AC voltage into a first DC voltage based on power factor correction, and
converting the first DC voltage into a second DC voltage,
wherein the rectifying the input voltage to output a first AC voltage comprises:
extracting a first half-wave voltage and a second half-wave voltage from the input voltage using at least one resistor,
inputting the first half-wave voltage and the second half-wave voltage to at least one operational amplifier,
controlling a gate of at least one switch based on the output of the operational amplifier, and
outputting the first AC voltage based on the operation of the at least one switch.

19. The method of claim 18, wherein the rectifying the input voltage to output the first AC voltage comprises:
providing an offset voltage to an input end of the at least one operational amplifier, and
controlling a turn-on time and a turn-off time of the at least one switch based on an amplification voltage output from the operational amplifier.

20. The method of claim 18, wherein the method further includes: controlling at least one of the bridge rectifier, the power factor corrector, and the DC-DC converter,
wherein the controlling at least one of the bridge rectifier, the power factor corrector, and the DC-DC converter comprises:
applying to a VINAC pin a VINAC voltage generated based on the first half-wave voltage and the second half-wave voltage being OR-ed, and
controlling at least one of the bridge rectifier, the power factor corrector, and the DC-DC converter, based on the VINAC voltage input through the VINAC pin.
